(19) United States
(12) Patent Application Publication
(10) Pub. No.: US 2018/0142646 A1
(43) Pub. Date: May 24, 2018

(54) SOLID ROCKET MOTOR WITH BARRIER

(71) Applicant: Aerojet Rocketdyne, Inc., Sacramento, CA (US)

(72) Inventors: Alan B. Minick, Huntsville, AL (US); Scott Dawley, Orange, VA (US)

(21) Appl. No.: 15/572,829

(22) PCT Filed: Jul. 27, 2016
(86) PCT No.: PCT/US2016/044194

§ 371 Date: Nov. 9, 2017

Related U.S. Application Data
(60) Provisional application No. 62/203,492, filed on Aug. 11, 2015.
(60) Provisional application No. 62/250,307, filed on Nov. 3, 2015.

(51) Int. Cl. F02K 9/34; F02K 9/10; F02K 9/97

(52) U.S. Cl. CPC F02K 9/346; F02K 9/10; F05D 2300/432; F05D 2300/182; F02K 9/97

(57) ABSTRACT

A solid rocket motor includes a propellant grain and a barrier shielding at least a portion of the grain. The barrier is impermeable to water, oxygen, nitrogen, and volatile solid propellant species.

### CROSS-REFERENCE TO RELATED APPLICATIONS

The present disclosure claims priority to United States Provisional Patent Application Nos. 62/203,492, filed Aug. 11, 2015 and 62/250,307, filed Nov. 3, 2015.

### BACKGROUND

Solid rocket motors typically include a solid propellant grain material that is cast around a core. The core is then removed by sliding it out from the cast grain material, leaving an open central bore. Ignition at the bore surface of the solid propellant generates high pressure gas, which is expelled from the bore through a nozzle to generate thrust.

### SUMMARY

A solid rocket motor according to an example of the present disclosure includes a propellant grain, and a barrier surrounding at least a portion of the grain. The barrier is impermeable to water, oxygen, nitrogen and volatile solid propellant species.

In a further embodiment of any of the foregoing embodiments, the barrier includes an aluminized polymer material.

In a further embodiment of any of the foregoing embodiments, the barrier is a hermetic barrier.

In a further embodiment of any of the foregoing embodiments, the barrier includes a barrier layer lining the bore.

In a further embodiment of any of the foregoing embodiments, the barrier layer includes a material selected from the group consisting of polymeric material, ceramic material, metallic material, and combinations thereof.

In a further embodiment of any of the foregoing embodiments, the barrier layer includes a substrate layer and a metallic layer disposed on the substrate layer.

In a further embodiment of any of the foregoing embodiments, the bore defines an axis, and the substrate layer is radially outwards of the metallic layer.

A further embodiment of any of the foregoing embodiments includes an ignition system that includes an ignition cord between the barrier and the propellant grain.

A further embodiment of any of the foregoing embodiments includes an ignition system operable to ignite the propellant grain. The ignition system has a multi-metallic ignition body having at least two metallic elements in contact with each other and a fluorine-containing body in contact with the multi-metallic ignition body.

In a further embodiment of any of the foregoing embodiments, the at least two metallic elements include aluminum and palladium.

In a further embodiment of any of the foregoing embodiments, the barrier includes the ignition system.

In a further embodiment of any of the foregoing embodiments, the ignition system at least partially seals the propellant grain.

In a further embodiment of any of the foregoing embodiments, the ignition system is attached to the propellant grain through the barrier.

In a further embodiment of any of the foregoing embodiments, the ignition system extends along a bore of the propellant grain.

In a further embodiment of any of the foregoing embodiments, the barrier lines a bore of the propellant grain.

A method according to an example of the present disclosure involves a solid rocket motor that has a propellant grain structure that defines a bore and a barrier in at least the bore that seals the propellant grain structure. The method includes igniting the propellant grain structure by: activating an ignition system that has a multi-metallic ignition body that has at least two metallic elements in contact with each other and a fluorine-containing body in contact with the multi-metallic ignition body, or at least partially removing the barrier to expose the propellant grain structure and igniting the exposed propellant grain structure.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example of a solid rocket motor with a barrier.

FIG. 2 illustrates a portion of a solid rocket motor and an ignition system.

FIG. 3A illustrates an ignition cord of an ignition system.

FIG. 3B illustrates a cross-section of the ignition cord of FIG. 3A.

FIG. 4 illustrates an example of a barrier layer.

FIG. 5 illustrates an example of a method of igniting a solid rocket motor that has a barrier.

### DETAILED DESCRIPTION

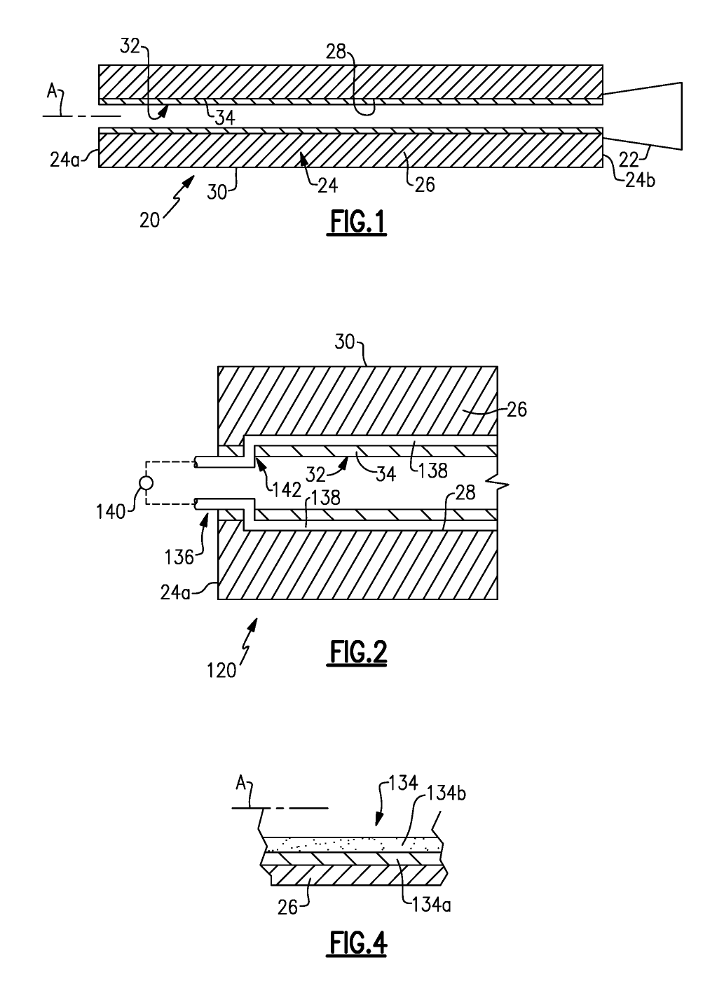

FIG. 1 schematically illustrates a cross-section of selected portions of a solid rocket motor 20. The solid rocket motor 20 generally includes a nozzle 22 and a solid propellant section 24. The solid propellant section 24 includes a forward end 24a and an aft end 24b. The aft end 24b is in communication with the nozzle 22. As will be appreciated, the solid rocket motor 20 may include additional components related to the operation thereof, which are generally known and thus not described herein.

The solid propellant section 24 includes a solid propellant grain structure 26 (hereafter “structure 26”). As an example, the structure 26 is formed of a solid propellant grain. The solid propellant grain is not particularly limited. Typically, the solid propellant grain includes a solid oxidizer, a solid fuel, a binder system that holds the solid oxidizer and the solid fuel together, and optionally performance additives and stabilizers. The solid propellant grain may be a mixture of the solid oxidizer, the solid fuel, and the binder system including, for example, powders or particulates of the solid oxidizer and the solid fuel. An example oxidizer can include, but is not limited to, ammonium perchlorate. Example fuels can include, but are not limited to, aluminum metal, cyclotetramethylene-tetranitramine (known as “HMX”), cyclotrimethylenetrinitramine (known as “RMX”), and combinations thereof. The binder system may include, but is not limited to, a polybutadiene-containing polymer, a hydrocarbon diluent component, and an anti-oxidant component.

The solid propellant grain is molded or otherwise formed into a shape, which constitutes the structure 26. The structure 26 typically defines, but is not limited to, an elongated bore 28. Alternatively, the structure 26 may be a solid (non-hollow) end-burning motor that does not have a bore. Although not shown, the structure may include other features, such as but not limited to, fin slots located toward the aft end 24b. The structure 26 is generally disposed within a motor case 30 about a central axis A.

Upon ignition the solid propellant grain reacts (e.g., burns) to produce high temperature and high pressure gas (combustion gas). The combustion gas discharges through the nozzle 22 to produce thrust.

Solid propellant grain can age prior to use, such as while a solid rocket motor is in storage for an extended period of time. For example, exposure to oxygen (air), water moisture (in air), and nitrogen (air) in the environment can lead to oxidation reactions, hydrolysis reactions, nitrogen reactions, hygroscopic reactions, and reformation reactions that may change the overall composition of the propellant grain and/or the chemistry of one or more constituents of the solid propellant grain. Diffusion and evaporation of one or more constituents of the solid propellant grain may change the overall composition of the propellant as well. In this regard, the solid rocket motor 20 includes a barrier 32 that surrounds at least a portion of the solid propellant grain. For example, the barrier 32 is in at least the bore 28. The barrier 32 seals the solid propellant grain material of the structure 26 and thereby serves as an atmospheric barrier or a hermetic barrier to protect the propellant grain material of the structure 26 from environmental exposure to oxygen, water moisture, nitrogen, and the like, as well as to impede diffusion and/or evaporation of constituents of the solid propellant grain. Since the bore 28 may be open and may contain air, the portion of the structure 26 that defines the bore 28 may be most susceptible to environmental exposure prior to use of the solid rocket motor 20. Thus, the barrier 32 covers at least the surfaces of the structure 26 in the bore 28. The case 30 may seal the radially outer portion of the structure 26. However, as can be appreciated, the barrier 32 may also be provided between the case 30 and the structure 26 and/or on end surfaces or other surfaces of the structure 26 where there is potential for environmental exposure. In some examples, the barrier 32 is on all surfaces of the structure 26 such that the barrier 32 fully encases the structure 26.

In the example shown, the barrier 32 includes a barrier layer 34 that lines the bore 28. For example, the barrier layer 34 is a liner, a coating, a film, a membrane, or other type of layer that is substantially impermeable to gaseous oxygen, gaseous nitrogen, and moisture and thus protects the propellant grain material from environmental exposure. In addition, the barrier 32 is impermeable to water, oxygen, nitrogen and volatile solid propellant species (e.g., plasiticizers) that exist in the solid propellant grain to escape. As an example, the barrier layer 34 may be formed of an aluminized coated polymer, aclar, or mylar material. The term impermeable means substantially resistant to permitting passage of a fluid or chemical species there through. For instance, the barrier layer 34 is formed of a material selected from polymeric material, ceramic material, metallic material, or combinations thereof. In further examples, the barrier layer 34 is predominantly formed of a polymer, a ceramic, or a metal in metallic form (e.g., elemental metal, alloy, or intermetallic compound). In further examples, the barrier layer 34 is polymeric and is formed from a paint. In further examples, the barrier layer 34 is a ceramic and is formed from a slurry coating. In further examples, the barrier layer 34 is a metal in metallic form and is formed from a metal deposition process. In one additional example, the barrier layer 34 is formed of the same polymer as is used in the binder system of the propellant grain material. In a further example, the barrier layer 34 has the same compositional constituents as the propellant grain, excluding the solid oxidizer, the solid fuel, or both. In further examples, the barrier layer 34 is a monolayer.

The barrier layer 34 may be applied to the structure 26 during formation (e.g., casting) of the propellant grain or after formation of the propellant grain. For example, the barrier layer 34 is prefabricated and is positioned in a casting mold. The propellant grain is then cast in the mold adjacent the barrier layer 34. Alternatively, the propellant grain is cast and, following casting, the barrier layer 34 is formed on the propellant grain of the structure 26. For example, a polymeric barrier 32, initially in the form of an emulsion (e.g., paint), is applied onto the surfaces of the propellant grain and dried/cured to form the barrier layer 34. Similarly, a ceramic slurry may be applied onto the surfaces of the propellant grain and dried/consolidated to form the barrier layer 34; or a metallic material may be deposited onto the surfaces of the propellant grain to form the barrier layer 34. In operation, the barrier 32 may be consumable and/or ejectable.

Solid rocket motors may be ignited using a pyrotechnic ignitor, such as boron potassium nitrate (BKNO₃). A pyrotechnic ignitor provides an initial heat source to a propellant grain material. Heat from hot combustion gases and solid combustion products of the pyrotechnic ignitor would typically impact an exposed surface of a propellant grain material to ignite the propellant grain material and raise it to a self-sustaining combustion level. However, the presence of the barrier 32 in the solid rocket motor 20 could potentially interfere with such impact and ignition. In this regard, FIG. 2 illustrates a portion of another example solid rocket motor 120 that includes an ignition system 136 that is operable to ignite the propellant grain of the structure 26.

In this example, the ignition system 136 includes one or more ignition cords 138 that are operable to generate heat in the structure 26 and thereby ignite the propellant grain. The ignition of the propellant grain and/or the operation of the ignition cord or cords 138 may also burn or shed the barrier 32. In this example, the ignition cord or cords 138 run along the surface of the propellant grain of the structure 26 adjacent the barrier 32. For instance, the ignition cord or cords 138 are circumferentially disposed between the structure 26 and the barrier 32. In a further example, one or more of the ignition cords 138 runs along the complete length or substantially complete length of the structure 26 with regard to the ends 24a/24b. In further examples, the ignition system 136 includes two or more ignition cords 138 that are spaced around the bore 28, to initiate ignition. The ignition system 136 may include, or may be connected to, a controller 140 to control initiation of ignition.

In the example shown, the barrier 32 includes at least a portion of the ignition cord or cords 138 of the ignition system 136. For instance, as shown at 142, the ignition cord or cords 138 extend through the barrier 32. In this regard, the barrier 32 seals around the ignition card or cords 138 at 142 the ignition system 136 is attached to the structure 26 through the barrier 32. The ignition system 136 thus at least partially seals the propellant grain at 142. As can be appreciated, although the ignition cord or cords 138 extend through the barrier 32 in the bore 28, the ignition cord or cords 138 could alternatively extend through the barrier 32 wherever present around the propellant grain, such as at other locations outside of the bore 28 (if present) or at the end 24a.

The ignition cord or cords 138 can be integrated through the barrier 32 during formation of the barrier 32. For instance, prior to or in conjunction with application of the barrier 32, the ignition cord or cords 138 are positioned in the location where the barrier 32 is to be applied. The barrier 32 is then applied to the surfaces of the propellant grain of the structure 26 such that the barrier 32 forms around the ignition cord or cords 138 at 142. As an example, a polymeric barrier 32, initially in the form of an emulsion (e.g., paint), is applied onto the surfaces and dries/cures around the ignition cord or cords 138 at 142. Similarly, a ceramic slurry may be applied around the ignition cord or cords 138 at 142, or a metallic material may be deposited around the ignition cord or cords 138 at 142.

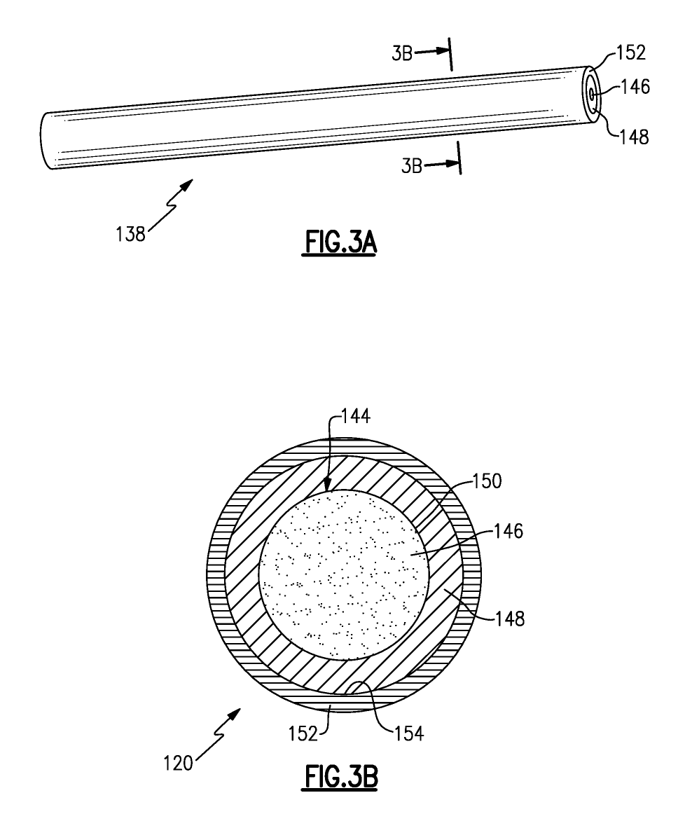

FIGS. 3A and 3B illustrate a representative portion of one of the ignition cords 138. In this example, the ignition cord 138 includes a multi-metallic ignition body 144 that has at least two metallic elements 146/148 in contact with each other. Although not limited, the metallic elements 146/148 are in contact at interface 150 in the example shown. The ignition cord 138 further includes a fluorine-containing body 152 in contact with the multi-metallic ignition body 144. Although also not limited, the fluorine-containing body 152 is in contact with the multi-metallic ignition body 144 at interface 154 in the example shown.

In this example, the metallic elements 146/148 and the fluorine-containing body 152 are each provided as layers. Such layers are generally of uniform thickness and can be flat or curved, for example. As will be appreciated given this disclosure, the metallic elements 146/148 of the multi-metallic ignition body 144 and/or the fluorine-containing body 152 may alternatively be provided in geometries other than layers.

The metallic elements 146/148, as well as additional metallic elements, if present, are reactive with each other, in the absence of oxygen, above an ignition initiation temperature. When heated above the ignition temperature by electric current or other energy source provided by the controller 140 the metallic elements react in an exothermic self-sustaining alloying reaction to generate heat. The self-sustaining alloying reaction proceeds until the alloying is complete. For instance, the alloying reaction is rapid and results in deflagration.

While the reaction between the metallic elements 146/148 alone releases heat, at least the fluorine in the fluorine-containing body 152 also reacts to augment thermal release beyond that of the metals alone. For example, the fluorine serves as an oxidant to react with the metallic elements, the reaction products of the metallic elements, or both in a pyrotechnic chemical reaction. The exothermic reactions between the metallic elements, the metallic elements with the fluorine, and/or the byproducts of the metallic elements and fluorine releases heat and generates hot gases. The hot gases may contain the metallic elements, metal fluorides, fluorine, and/or metal carbides of the metallic elements. The hot gases rapidly heat the solid propellant grain of the structure 26 to initiate ignition.

In one example, the metallic elements 146/148 are based upon at least palladium and aluminum. For example the metallic element 146 is aluminum or an aluminum-based alloy and the metallic element 148 is palladium or a palladium-based alloy. Although not limited, one example of a useful aluminum alloy is aluminum alloy 5056, which has, by weight, approximately 5% magnesium, approximately 0.12% manganese, approximately 0.12% chromium, and a remainder of aluminum and any impurities.

In a further example, the multi-metallic ignition body 144 includes ruthenium as an additional, reactive metallic element. The ruthenium may be provided as an alloy with the palladium. In one example the palladium-ruthenium alloy includes, by weight, approximately 95% palladium and approximately 5% ruthenium.

In additional examples, the fluorine-containing body 152 is a fluorine-containing polymer. One example of a fluorine-containing polymer is a fluorocarbon polymer. As used herein, a fluorocarbon polymer is a polymer that has carbon-fluorine bonds. Non-limiting examples of fluorine-containing polymers include polytetrafluoroethylene (PTFE), fluorinated ethylene propylene (FEP), polyvinylidene fluoride (PVF), hexafluoropropylene (HFP), polyvinylfluoride (PVD), polyethylenetetrafluoroethylene (ETFE), and combinations thereof.

In the illustrated example the ignition cord 138 is in the form of a wire or filament. The metallic element 146 is provided as an inner core and the metallic element 148 is provided as an outer jacket that encases or circumscribes the inner core. The outer jacket may include palladium or palladium-ruthenium alloy as described above, and the inner core may include aluminum or aluminum alloy as described above. One example of the metallic elements 146/148 is PYROFUZE® (Sigmund Cohn Corp.). In the example shown, the wire or filament is substantially circular in cross-section. Alternatively, rather than circular, the wire or filament may be flat in the form of a ribbon. The examples herein may also be adapted to other geometries, such as but not limited to, rolled structures, intertwined structures, braided structures, divided/chopped structures, pressed rope structures, pressed block structures, and the like.

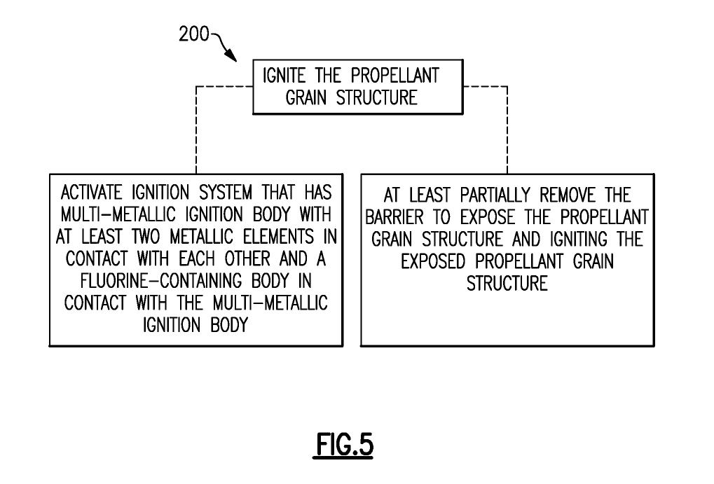

FIG. 4 shows a representative portion of another example barrier layer 134. In this example, the barrier layer 134 has a multi-layer structure that includes a substrate layer 134a and a metallic layer 134b. For example, the substrate layer 134a includes a polymeric material or predominantly includes a polymer, and the metallic layer 134b includes a metallic material or predominantly includes a metal in metallic form. The polymer may be, but is not limited to, polyethylene terephthalate (PET) or polychlorotrifluoroethylene (PCTFE). The metal may be, but is not limited to, aluminum. With respect to the central axis A, the substrate layer 134a faces the structure 26 and, if in the bore 28, is radially outwards of the metallic layer 134b. The metallic layer 134b thus faces into the open cavity defined by the bore 28.

Although the barrier layer 134 may be used in combination with the ignition system 136, the barrier layer 134 may alternatively be used with a pyrotechnic ignitor. Heat and pressurized gas from the pyrotechnic ignitor at least partially removes the barrier 132 to expose at least a portion of the structure 26. The pyrotechnic ignitor can then ignite the exposed structure 26.

FIG. 5 schematically illustrates an example method 200 of igniting the solid rocket motor 20. The method 200 involves igniting the structure 26 by i) activating the ignition system 136 that has the one or more ignition cords 138 as described above or ii) at least partially removing the barrier 32/132 to expose the propellant grain of the structure 26 and igniting the exposed grain. Although approach i) and approach ii) may be used together, one or the other of these approaches will typically be selected in a design stage as the ignition strategy for a given implementation of the solid rocket motor 20. The ignition approach may be selected in combination with selection of the barrier 32/132. For example, when the selected barrier 32/132 is of composition and structure that can be readily consumed by a pyrotechnic ignitor, such as by shedding, burning, or a combination thereof, approach ii) may be selected/utilized. Alternatively, when the selected barrier 32/132 cannot be readily consumed, approach i) may be selected/utilized. Given this disclosure, those of ordinary skill in the art will be able to determine through regular experimentation which approach may be suited to a particular selected barrier 32/132.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A solid rocket motor comprising:
a propellant grain; and
a barrier surrounding at least a portion of the grain, wherein the barrier is impermeable to water, oxygen, nitrogen and volatile solid propellant species.

2. The solid rocket motor as recited in claim 1, wherein the barrier includes an aluminized polymer material.

3. The solid rocket motor as recited in claim 1, wherein the barrier is a hermetic barrier.

4. The solid rocket motor as recited in claim 1, wherein the barrier includes a barrier layer lining the bore.

5. The solid rocket motor as recited in claim 4, wherein the barrier layer includes a material selected from the group consisting of polymeric material, ceramic material, metallic material, and combinations thereof.

6. The solid rocket motor as recited in claim 4, wherein the barrier layer includes a substrate layer and a metallic layer disposed on the substrate layer.

7. The solid rocket motor as recited in claim 6, wherein the bore defines an axis, and the substrate layer is radially outwards of the metallic layer.

8. The solid rocket motor as recited in claim 1, further comprising an ignition system that includes an ignition cord between the barrier and the propellant grain.

9. The solid rocket motor as recited in claim 1, further comprising an ignition system operable to ignite the propellant grain, the ignition system including a multi-metallic ignition body having at least two metallic elements in contact with each other and a fluorine-containing body in contact with the multi-metallic ignition body.

10. The solid rocket motor as recited in claim 9, wherein the at least two metallic elements include aluminum and palladium.

11. The solid rocket motor as recited in claim 9, wherein the barrier includes the ignition system.

12. The solid rocket motor as recited in claim 9, wherein the ignition system at least partially seals the propellant grain.

13. The solid rocket motor as recited in claim 9, wherein the ignition system is attached to the propellant grain through the barrier.

14. The solid rocket motor as recited in claim 9, wherein the ignition system extends along a bore of the propellant grain.

15. The solid rocket motor as recited in claim 1, wherein the barrier lines a bore of the propellant grain.

16. A method comprising:
in a solid rocket motor that includes a propellant grain structure that defines a bore and a barrier in at least the bore that seals the propellant grain structure, igniting the propellant grain structure by:
i) activating an ignition system that has a multi-metallic ignition body that has at least two metallic elements in contact with each other and a fluorine-containing body in contact with the multi-metallic ignition body, or
ii) at least partially removing the barrier to expose the propellant grain structure and igniting the exposed propellant grain structure.

17. The method as recited in claim 16, including igniting the propellant grain structure by i).

18. The method as recited in claim 16, including igniting the propellant grain structure by ii).
